(19) United States
(12) Patent Application Publication
(10) Pub. No.: US 2022/0039389 A1
(43) Pub. Date: Feb. 10, 2022

(54) METHOD AND DEVICE FOR STORING AND DISPENSING AN ANTIMICROBIAL SOLUTION

(71) Applicant: Parasol Medical, LLC, Buffalo Grove, IL (US)

(72) Inventor: Patrick E. Eddy, Allendale, MI (US)

(21) Appl. No.: 17/397,434

(22) Filed: Aug. 9, 2021

Related U.S. Application Data
(60) Provisional application No. 62/706,277, filed on Aug. 7, 2020.

(51) Int. Cl. A01N 55/00; A01N 25/06; A01N 31/02; A01N 59/00; B65D 83/62; B65D 83/44

(52) U.S. Cl. CPC A01N 55/00; A01N 25/06; B65D 83/44; A01N 59/00; B65D 83/62; A01N 31/02

(57) ABSTRACT

A method is provided for storing and dispensing an antimicrobial solution including providing a bag-on-valve can, and filling the bag-on-valve can with the antimicrobial solution, the antimicrobial solution comprising a silane quaternary ammonium ion or salt thereof. The silane quaternary ammonium ion or salt thereof can be one or more of:
3-(trimethoxysilyl)propyldimethyloctadecyl ammonium ion,
3-(trimethoxysilyl)propyldimethyloctadecyl ammonium chloride,
3-(trihydroxysilyl)propyldimethyloctadecyl ammonium ion, and
3-(trihydroxysilyl)propyldimethyloctadecyl ammonium chloride.
   The solution can further include any one or more of water, isopropyl alcohol, hydrogen peroxide, and hypochlorous acid. A bag-on-valve can is also provided for storing and dispensing an antimicrobial solution, the bag-on-valve can including: a can having an opening; a valve sealed in the opening of the can; a bag attached to the valve and provided in the can, wherein the bag is filled with the antimicrobial solution, which includes a silane quaternary ammonium ion or salt thereof; and an actuator for dispensing the solution.

### CROSS-REFERENCE TO RELATED APPLICATION

This application claims priority to and the benefit under 35 U.S.C. § 119(e) of U.S. Provisional Patent Application No. 62/706,277, filed on Aug. 7, 2020, entitled “METHOD AND DEVICE FOR STORING AND DISPENSING AN ANTIMICROBIAL SOLUTION,” by Patrick E. Eddy, the entire disclosure of which is incorporated herein by reference.

### BACKGROUND OF THE INVENTION

The present invention generally pertains to a method and a device for storing and dispensing an antimicrobial solution, and more particularly, to a method and a device for storing and dispensing a silane quaternary ammonium ion or salt thereof.

### SUMMARY OF THE INVENTION

According to one aspect of the present invention, a method is provided for storing and dispensing an antimicrobial solution comprising: providing a bag-on-valve can; and filling the bag-on-valve can with the antimicrobial solution, the antimicrobial solution comprising a silane quaternary ammonium ion or salt thereof.

According to one aspect of the present invention, a bag-on-valve can is provided for storing and dispensing an antimicrobial solution. The bag-on-valve can comprises: a can having an opening; a valve sealed in the opening of the can; a bag attached to the valve and provided in the can, wherein the bag is filled with the antimicrobial solution, the antimicrobial solution comprising a silane quaternary ammonium ion or salt thereof; and an actuator for actuating the valve in order to dispense the antimicrobial solution.

According to one aspect of the present invention, a method of storing and dispensing an antimicrobial solution comprises: providing a bag-on-valve can; and filling the bag-on-valve can with the antimicrobial solution, the antimicrobial solution comprising a silane quaternary ammonium ion or salt thereof, wherein the silane quaternary ammonium ion or salt thereof is one or more of:
3-(trimethoxysilyl)propyldimethyloctadecyl ammonium ion,
3-(trimethoxysilyl)propyldimethyloctadecyl ammonium chloride,
3-(trihydroxysilyl)propyldimethyloctadecyl ammonium ion, and
3-(trihydroxysilyl)propyldimethyloctadecyl ammonium chloride.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1 is a cross-sectional view of a bag-on-valve can;

FIGS. 2A-2F are cross-sectional and perspective views of the assembly and filling of the bag-on-valve can shown in FIG. 1; and

FIG. 3 is a flow chart illustrating the method of assembling and filling the bag-on-valve can shown in FIG. 1.

### DETAILED DESCRIPTION

The present illustrated embodiments reside primarily in combinations of method steps and apparatus components related to a bag-on-valve can. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

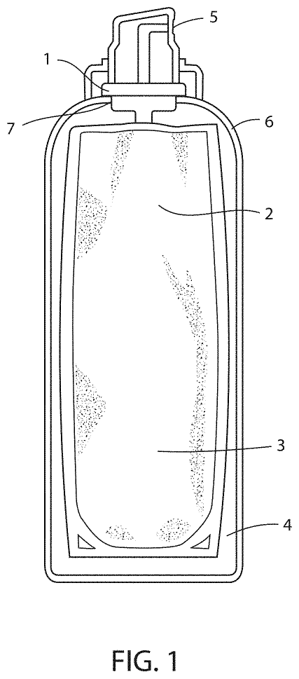

For purposes of description herein, the terms “upper,” “lower,” “right,” “left,” “rear,” “front,” “vertical,” “horizontal,” and derivatives thereof shall relate to the invention as oriented in FIG. 1. Unless stated otherwise, the term “front” shall refer to the surface of the device closer to an intended viewer of the device, and the term “rear” shall refer to the surface of the device further from the intended viewer of the device. However, it is to be understood that the invention may assume various alternative orientations, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements, but may include other elements not expressly listed or inherent to such process, method, article, or apparatus. An element preceded by “comprises a . . . ” does not, without more constraints, preclude the existence of additional identical elements in the process, method, article, or apparatus that comprises the element.

FIG. 1 shows an example of a bag-on-valve can 10 in which the antimicrobial solution 3 may be stored and dispensed. The bag-on-valve can 10 may include a can 6 having an opening 7, a valve 1 sealed in the opening 7 of the can 6, a bag 2 attached to the valve 1 and provided in the can 6, wherein the bag 2 is filled with the antimicrobial solution 3, the antimicrobial solution 3 comprising a silane quaternary ammonium ion or salt thereof; and an actuator 5 for actuating the valve 1 in order to dispense the antimicrobial solution 3. The can 6 may further contain a propellant 4 outside the bag 2.

The bag 2 may be a laminated aluminum bag, or may be made of polyethylene terephthalate (PET), polypropylene (PP), or polyethylene (PE). The can 6 may be made of aluminum or tin plate. The propellant 4 may be compressed air or nitrogen. The propellant 4 may have a pressure of 30-80 psi.

The antimicrobial solution 3 comprises a silane quaternary ammonium ion or salt thereof. The silane quaternary ammonium ion or salt thereof may be one or more of:
3-(trimethoxysilyl)propyldimethyloctadecyl ammonium ion,
3-(trimethoxysilyl)propyldimethyloctadecyl ammonium chloride,
3-(trihydroxysilyl)propyldimethyloctadecyl ammonium ion, and
3-(trihydroxysilyl)propyldimethyloctadecyl ammonium chloride.

The solution includes a liquid component that carries the silane quaternary ammonium ion or salt to the surface to be treated, allowing the silane quaternary ammonium ion or salt to bond to the treated surface. The liquid component dries off leaving the silane quaternary ammonium ion or salt to be bonded to the treated surface. The silane quaternary ammonium ion or salt thereof is not necessarily known for quick-acting microbial reduction like a disinfectant. However, the silane quaternary ammonium ion or salt thereof provides residual long-lasting antimicrobial activity that is not consumed while destroying the virus or other microbe. The silane quaternary ammonium ion or salt thereof may be between 0.1 percent and 10 percent by weight of the solution.

The antimicrobial solution may further comprise water as the liquid component. The solution may further comprise isopropyl alcohol as the liquid component (solvent). In embodiments, the isopropyl alcohol is between 30 percent to 90 percent by weight of the solution. The solution may include both water and isopropyl alcohol. An example solution comprises (by weight) 60.0 percent isopropyl alcohol, 2.02 percent 3-(trimethoxysilyl)propyldimethyloctadecyl ammonium chloride, and 34.19 percent deionized water.

The antimicrobial solution may further comprise hydrogen peroxide. The hydrogen peroxide may be 0.05 percent by weight to 7.5 percent by weight of the solution. The hydrogen peroxide operates as a disinfectant, which compliments the long-lasting antimicrobial properties of the silane quaternary ammonium ion or salt.

The antimicrobial solution may further comprise hypochlorous acid. The solution may further comprise hypochlorous acid, a silane quaternary ammonium ion or salt thereof, and water. The hypochlorous acid may exist in the solution at a concentration of 0.1 to 1000 ppm. The hypochlorous acid may exist in the solution at a concentration of 0.1 to 200 ppm. The hypochlorous acid may exist in the solution at a concentration of 200 to 1000 ppm. The hypochlorous acid operates as a disinfectant, which compliments the long-lasting antimicrobial properties of the silane quaternary ammonium ion or salt.

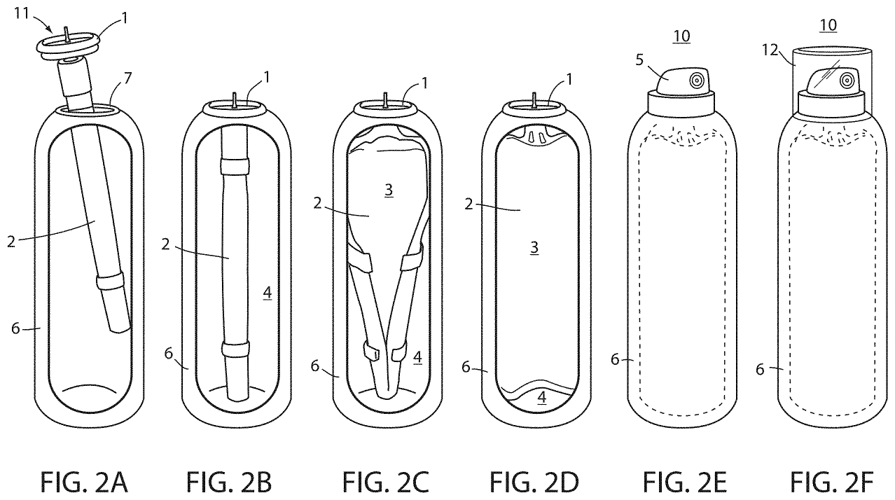

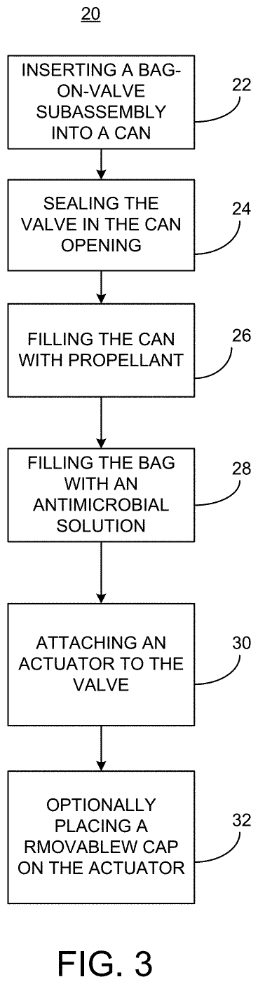

Referring now to FIGS. 2A-2F and FIG. 3, a method 20 of storing the antimicrobial solution in a bag-on-valve can 10 is described. The first step 22 in the method 20 is to insert a bag-on-valve subassembly 11 into the opening 7 of the can 6. The bag-on-valve subassembly 11 includes the valve 1 and the bag 2. This is shown in FIG. 2A.

As shown in FIG. 2B and FIG. 3, the next step 24 is to seal the valve 1 in the can opening 7. Then in step 26, the can 6 may be filled with propellant 4. Alternatively, the first step 22 of inserting the subassembly 11 into the can 6 may be performed in a propellant-rich pressurized environment so that when the sealing step 24 occurs, the propellant 4 is already in the can 6.

Next, in step 28, the bag 2 is filled with the antimicrobial solution 3 through the valve 1. This step is illustrated in FIGS. 2C and 2D. Then, in step 30, the actuator 5 is attached to the can 6 and valve 1 as shown in FIG. 2E. Last, in step 32, an optional removable cap 12 is placed over the actuator 5 as shown in FIG. 2F.

It is to be understood that variations and modifications can be made on the aforementioned structure without departing from the concepts of the present invention, and further it is to be understood that such concepts are intended to be covered by the following claims unless these claims by their language expressly state otherwise.

The invention claimed is:

1. A method of storing and dispensing an antimicrobial solution comprising:
providing a bag-on-valve can; and
filling the bag-on-valve can with the antimicrobial solution, the antimicrobial solution comprising a silane quaternary ammonium ion or salt thereof.

2. The method of claim 1, wherein
the silane quaternary ammonium ion or salt thereof is one or more of:
3-(trimethoxysilyl)propyldimethyloctadecyl ammonium ion,
3-(trimethoxysilyl)propyldimethyloctadecyl ammonium chloride,
3-(trihydroxysilyl)propyldimethyloctadecyl ammonium ion, and
3-(trihydroxysilyl)propyldimethyloctadecyl ammonium chloride.

3. The method of claim 1, wherein
the antimicrobial solution further comprises isopropyl alcohol.

4. The method of claim 1, wherein
the antimicrobial solution further comprises hydrogen peroxide.

5. The method of claim 1, wherein
the antimicrobial solution further comprises hypochlorous acid.

6. The method of claim 1, wherein
the antimicrobial solution further comprises water.

7. A bag-on-valve can for storing and dispensing an antimicrobial solution, the bag-on-valve can comprising:
a can having an opening;
a valve sealed in the opening of the can;
a bag attached to the valve and provided in the can, wherein the bag is filled with the antimicrobial solution, the antimicrobial solution comprising a silane quaternary ammonium ion or salt thereof; and
an actuator for actuating the valve in order to dispense the antimicrobial solution.

8. The bag-on-valve can of claim 7, wherein
the silane quaternary ammonium ion or salt thereof is one or more of:
3-(trimethoxysilyl)propyldimethyloctadecyl ammonium ion,
3-(trimethoxysilyl)propyldimethyloctadecyl ammonium chloride,
3-(trihydroxysilyl)propyldimethyloctadecyl ammonium ion, and
3-(trihydroxysilyl)propyldimethyloctadecyl ammonium chloride.

9. The bag-on-valve can of claim 7, wherein
the antimicrobial solution further comprises isopropyl alcohol.

10. The bag-on-valve can of claim 7, wherein
the antimicrobial solution further comprises hydrogen peroxide.

11. The bag-on-valve can of claim 7, wherein
the antimicrobial solution further comprises hypochlorous acid.

12. The bag-on-valve can of claim 7, wherein
the antimicrobial solution further comprises water.

13. A method of storing and dispensing an antimicrobial solution comprising:
providing a bag-on-valve can; and
filling the bag-on-valve can with the antimicrobial solution, the antimicrobial solution comprising a silane quaternary ammonium ion or salt thereof, wherein the silane quaternary ammonium ion or salt thereof is one or more of:
3-(trimethoxysilyl)propyldimethyloctadecyl ammonium ion,
3-(trimethoxysilyl)propyldimethyloctadecyl ammonium chloride,
3-(trihydroxysilyl)propyldimethyloctadecyl ammonium ion, and
3-(trihydroxysilyl)propyldimethyloctadecyl ammonium chloride.

14. The method of claim 13, wherein
the antimicrobial solution further comprises isopropyl alcohol.

15. The method of claim 13, wherein
the antimicrobial solution further comprises hydrogen peroxide.

16. The method of claim 13, wherein
the antimicrobial solution further comprises hypochlorous acid.

17. The method of claim 13, wherein
the antimicrobial solution further comprises water.
